(19) United States
(12) Patent Application Publication
(10) Pub. No.: US 2012/0211560 A1
(43) Pub. Date: Aug. 23, 2012

(54) Ordering System Using Radio Frequency Identification

(76) Inventors: Penn Hsiao Su, Taichung City (TW); Min-Hsiu Su Hsiao, Taichung City (TW); Lynn Hsiao Su, Taichung City (TW)

(21) Appl. No.: 13/032,697

(22) Filed: Feb. 23, 2011

(51) Int. Cl. G06Q 90/00; G06F 17/00

(52) U.S. Cl. 235/380; 235/375

(57) ABSTRACT

An ordering system using radio frequency identification. is interactive and can track the processing status in real time, the system at least includes a menu having a RFID tag, a customer display device, a kitchen display device, a service display device, and a host display device. The menu having a RFID tag includes items each disposed with a RFID tag switch for a customer to select the item by pressing the RFID tag switch. When pressed, the RFID tag switch is turned on and transmits a signal to a reader for the reader to generate real-time ordering information on a display device, which is provided for corresponding the customer with an attendant for ordering information service, wherein the reader can also simultaneously transmit the ordering information to the kitchen display device, the service display device, and the host display device for preparing a meal, delivering the meal and preparing a bill, thereby informing the customer with the processing status on the go and improving the meal ordering/delivering efficiency.

### BACKGROUND OF THE INVENTION

1. Field of the Invention

The present invention relates to an ordering system using radio frequency identification, and more particularly, to an ordering system using radio frequency identification to enhance ordering convenience, to let customers be aware of the current processing status, and to smoothen the operation of the restaurant, thereby enhancing ordering efficiency and reducing cost.

2. Description of the Prior Art

The service industry including all kinds of restaurants keeps improving to attract more customers. In a traditional ordering process, when a customer arrives at the restaurant, an attendant guides the customer to a seat and provides a menu for the customer to order. Thereafter, the attendant writes down or marks the customer's order on a carbon paper and passes the duplicated copies done by the carbon paper to the customer, the counter and the kitchen, wherein the duplicated copies are treated as a bill for the customer to check out and also an order for the kitchen to prepare a meal. However, the traditional ordering process presents some shortcomings:

1. The customer may spend too much time looking at the menu and keep the attendant waiting, so the attendant can not serve other customers;

2. The attendant needs to deliver the customer's order to the kitchen, when the restaurant is big, the attendant may spend quite an amount of time traveling between the tables and the kitchen.

3. The kitchen could prepare a wrong dish due to handwriting errors or unrecognizable handwritings and has to throw it away.

4. When customers don't get their meal right or have to wait long for their meals due to insufficient ordering information, they tend to have bad impressions on the restaurant and may complain.

Therefore, various automatic ordering systems have been proposed, such as the Taiwan patent no. 459211 titled “An automatic ordering and billing system using IR communication for a fast food restaurant”, Taiwan patent no. 479175 titled “ordering data management system”, patent no. I257581 titled “Meal management system using RFID and a method thereof”, and patent no. M388697 titled “ordering system based on digital image”. In Taiwan patent no. I257581, a meal management system using radio frequency identification (RFID) is disclosed, which comprises a central server, at least one ordering device, at least one meal serving device, at least one management device, at least one RFID customer tag, and at least one RFID plate tag. The central server stores customer data, personalized menu, billing program, customer ID and plate ID; the ordering device comprises a display and a RFID reader; the meal serving device comprises a display and a RFID reader; the management device comprises a display and a RFID reader; the RFID customer tag identifies the customer; the RFID plate tag identifies the plate; wherein the central server, the ordering device, the meal serving device, and the management device are mutually connected via a network. However, the system is complicated and cannot provide a total solution for the whole restaurant management process; meanwhile, the system fails to let customers be aware of the current processing status and cannot effectively improve service efficiency, in other word, the ordering system cannot fully satisfy the requirement for practical use.

As to prior art techniques regarding RFID ordering system, please also refer to patents CN101620685A, CN101689223A, JP2005234789A, JP2006178627A, JP2008003926A, JP2008046755A, JP2009230633A, KR20070074038A, KR20070074039A, KR20080007721A, KR20090031024A, U.S. Pat. No. 6,116,505A, US2007139686A1, US2008156865A1, and WO2009036582A1.

### SUMMARY OF THE INVENTION

It is an object of the present invention to provide an ordering system using radio frequency identification which can guide a customer step by step through the ordering process based on practical operation and installation conditions to let the customer use the system efficiently.

It is another object of the present invention to provide an ordering system using radio frequency identification to let a customer order his/her meal with RFID techniques and to let the attendant at the counter and the kitchen to know the customer's requirements synchronously to integrate the whole restaurant management process.

It is another object of the present invention to provide an ordering system using radio frequency identification which can serve every dish correctly to the target table to improve the meal serving efficiency.

It is another object of the present invention to provide an ordering system using radio frequency identification which can let the customer be aware of the current processing status and can facilitate billing management to achieve restaurant management automation.

In order to achieve the above objects, the present invention discloses an ordering system using radio frequency identification, comprising a menu having a RFID tag, wherein the menu having a RFID tag comprises items each disposed with a RFID tag switch underneath for a customer to select the item by pressing the RFID tag switch to turn on the switch and to transmit a signal to a reader; wherein the reader generates real-time ordering information to be shown on a display device and provided for corresponding the customer with an attendant for ordering information service.

The ordering system using radio frequency identification further comprises:

a customer display device comprises a customer display device installed on a table for displaying, receiving and delivering ordering information; the customer display device can be electrically connected to the menu and integrated with the menu as a single device;

a kitchen display device installed in a cooking terminal of the kitchen for displaying, receiving and delivering ordering information, wherein the kitchen display device comprises a user interface for inputting data, the kitchen display device also connects with a RFID tag programmer for generating one or more RFID tags corresponding to the ordering information to be attached to a utensil;

a service display device installed at an attendant post for displaying, receiving and delivering ordering information, wherein the service display device comprises a user interface for inputting data and connects with a reader;

a host display device installed at a management desk or a counter for displaying, receiving, delivering ordering information and managing backend data, wherein the host display device comprises a user interface for inputting data.

### BRIEF DESCRIPTION OF THE DRAWINGS

The drawings disclose an illustrative embodiment of the present invention which serves to exemplify the various advantages and objects hereof, and are as follows:

FIG. 1 illustrates functional blocks of a structure of an ordering system using radio frequency identification and the system implementation;

FIG. 2 illustrates a diagram showing the lay out of the ordering system using radio frequency identification on a table;

FIG. 3 illustrates a structural diagram of a menu of the ordering system using radio frequency identification;

FIG. 4 illustrates a sectional view of the ordering system using radio frequency identification along the section A-A; and

FIG. 5 illustrates a view of pressing the ordering system using radio frequency identification along the section A-A.

### DETAILED DESCRIPTION OF THE PREFERRED EMBODIMENT

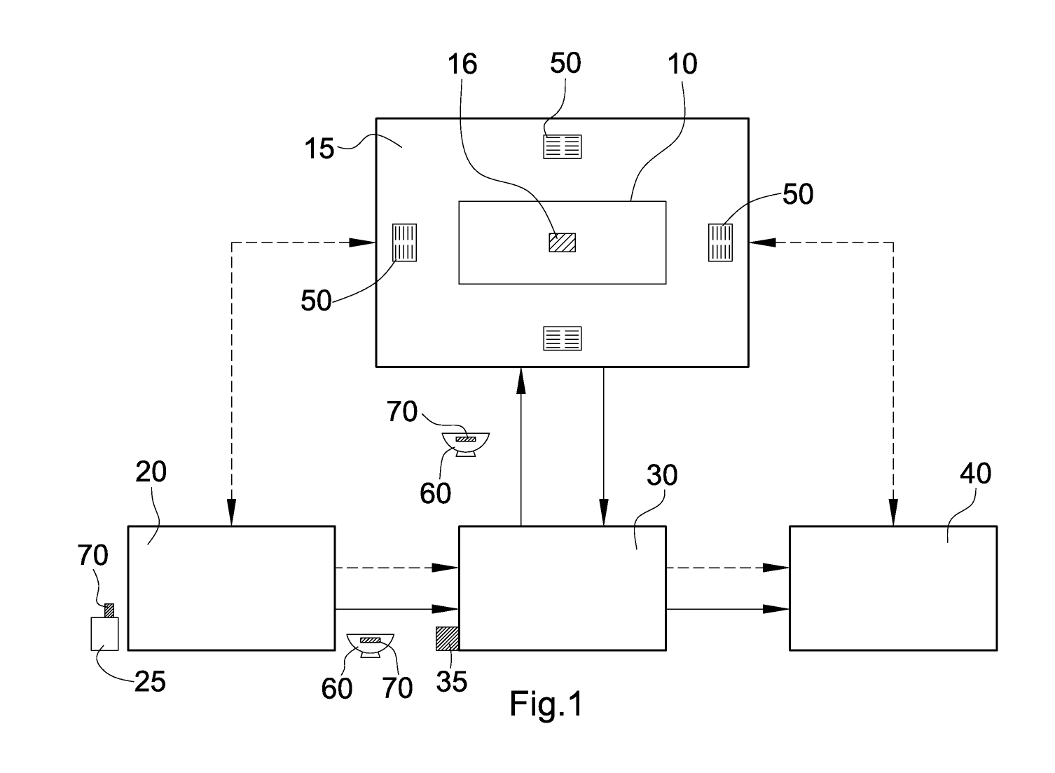

Please refer to FIG. 1 for an ordering system using radio frequency identification (RFID), which mainly comprises a radio frequency identification menu 50 having RFID tags, wherein the menu having RFID tags comprises items 51 each disposed with a RFID tag switch 53 for a customer to select the item 51 by pressing the RFID tag switch 53 to turn on the switch 53 and to transmit a signal to a reader 16; wherein the reader 16 generates real-time ordering information to be shown on a display device and provided for corresponding the customer with an attendant for ordering information service

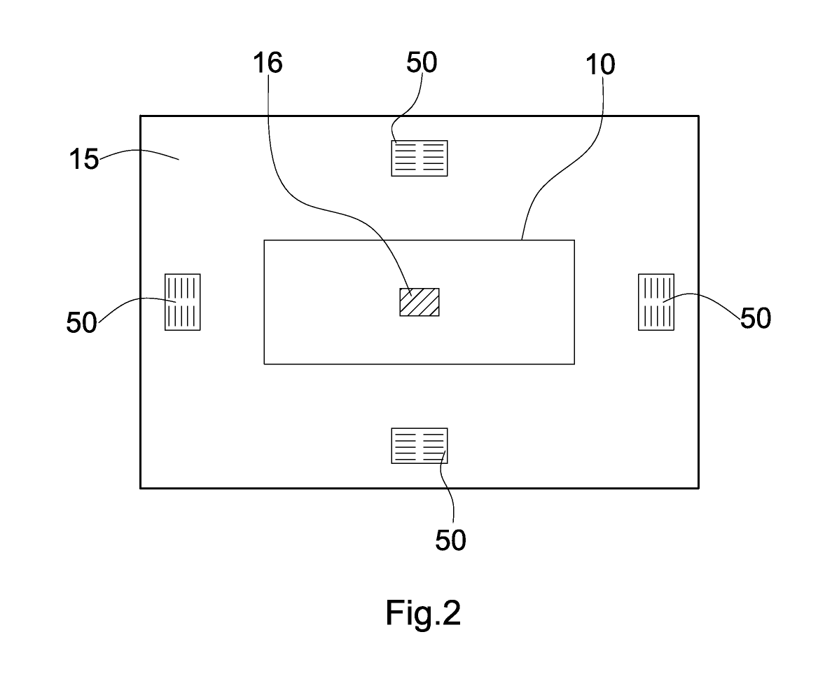

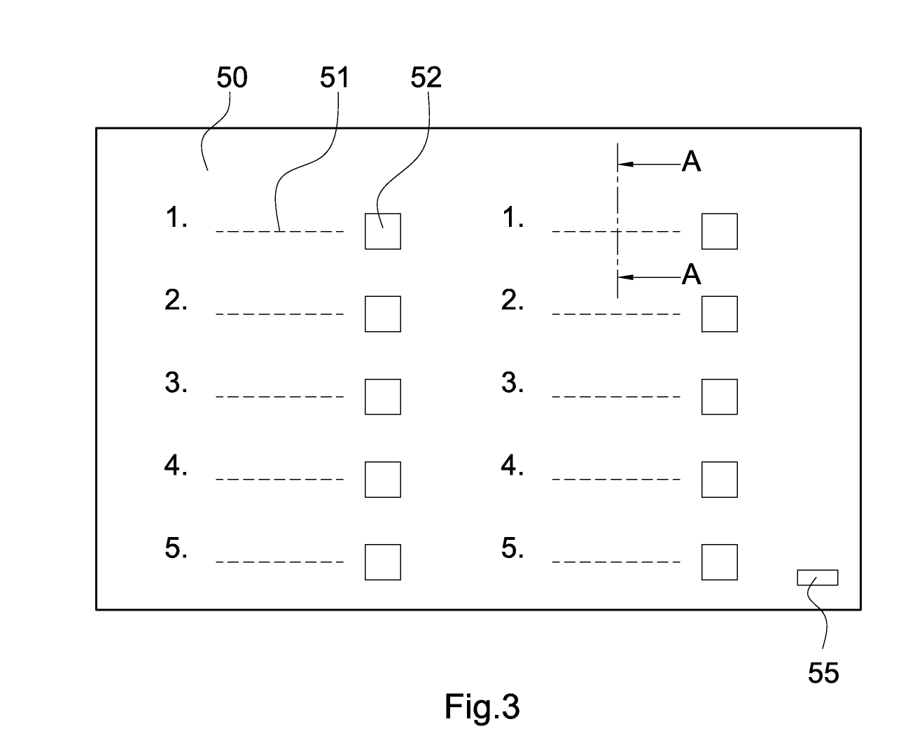

Please refer to FIG. 1, FIG. 2, and FIG. 3 for the implementation views of the present invention. In one embodiment of the present invention, the present invention is illustrated with the RFID tag switch 53 of the menu 50. When a customer presses a select button 52 of the item 51 to turn on the RFID tag switch 53, a chip inside the RFID tag 70 will process the data stored in the chip or the data received from the switch 53 according to a received command, such as power on, reset, calibration, data symbol correct, and global command, etc.; then the chip of the RFID tag 70 will return data according to the set command and transmits the identification of the RFID tag 70 to the reader 16 via wireless transmission as a confirmation and for further control operation, wherein the data is also shown on a display device of the reader 16 to provide real time ordering information for the attendant and the customer.

In the present invention, the RFID tag switch 53 can be a common capacitive touch sensor switch or a resistive touch sensor switch, the RFID tag switch 53 is implemented by coating a very thin metal oxide film on the menu 50 as the touch sensor switch. When a customer touches the touch sensor switch on the menu 50, the capacitive touch sensor switch generates a capacitance variation signal; if the resistive touch sensor switch is used, then the resistive touch sensor switch generates a voltage variation signal; both touch sensor switches output signals through a plurality of conducting wires to the reader 16 and provide real time ordering information for the attendant and the customer through the display device of the reader 16.

The ordering system using radio frequency identification further comprises the followings:

A customer display device 10 is installed on each table 15 for displaying, receiving and delivering ordering information; the customer display device 10 can be electrically connected to the menu 50 and integrated with the menu as a single device;

A kitchen display device 20 is installed in each cooking terminal of the kitchen for displaying, receiving and delivering ordering information, and the kitchen display device 20 comprises a user interface for inputting data, wherein the user interface can be selected from a keyboard, a mouse or a touch panel; the kitchen display device 20 also connects with a RFID tag programmer 25 for generating one or more RFID tags 70 corresponding to the ordering information of each table for the cooks to attach the RFID tag 70 to a utensil 60;

Additionally, a service display device 30 is installed at each attendant post for displaying, receiving and delivering ordering information, and the service display device 30 comprises a user interface for inputting data, wherein the user interface can be selected from a keyboard, a mouse or a touch panel, in the embodiment, the user interface is a touch panel; then the service display device 30 is connected with a reader 35, the reader 35 reads the RFID tag 70 on a utensil 60 to let the attendant know the correct table 15, the reader 35 can also read the utensil 60 retrieved from the table 15 to provide information about the current meal serving status, delivering speed and the table cleanness;

Additionally, a host display device 40 is installed at a management desk or a counter for displaying, receiving, delivering ordering information and managing backend data, and the host display device 40 comprises a user interface for inputting data, wherein the user interface can be selected from a keyboard, a mouse or a touch panel, in the embodiment, the user interface is a touch panel; the host display device 40 is also connected with a credit card, an electronic wallet, or the like to let the customer check out at the table;

Furthermore, the customer can use the radio frequency identification menu 50 at different tables, wherein the menu 50 comprises a plurality of items 51, each item 51 corresponds to a select button 52 for the customer to pre-order the corresponding item 51, the menu 50 is also disposed with one or more confirm buttons 55 for the customer to confirm the order after the order is done.

Therefore, the components mentioned above can construct an ordering system using the radio frequency identification menu 50 to provide interactivity and real-time processing status.

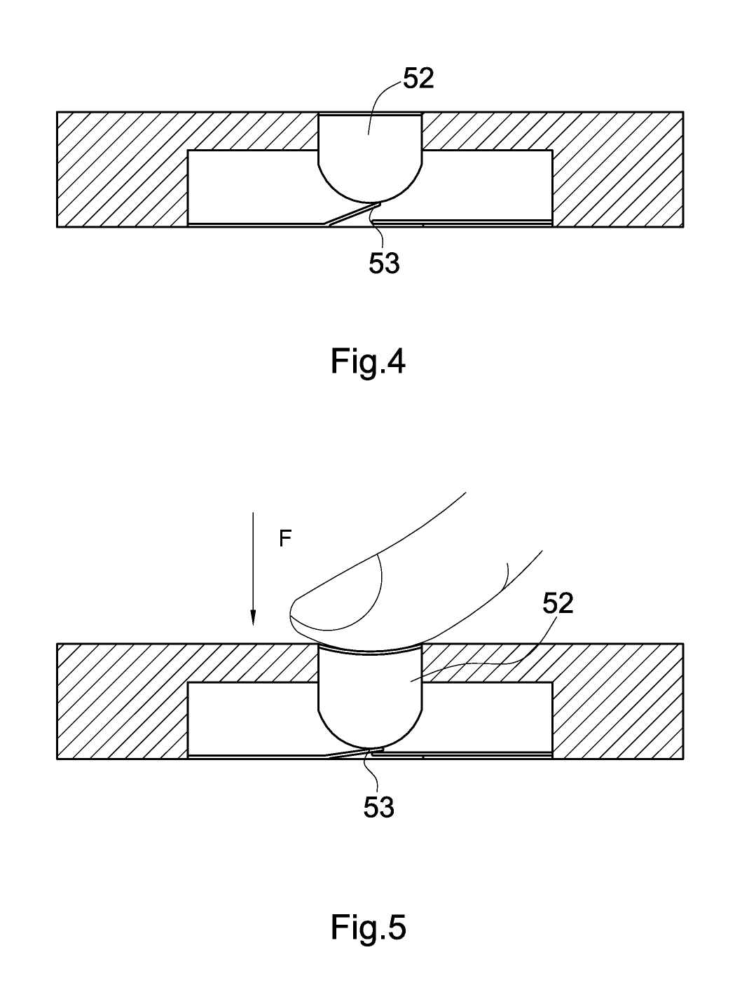

Please refer to FIG. 1 to FIG. 5 for an embodiment of applying the ordering system using radio frequency identification, wherein the steps are as follows:

First, when a customer enters the restaurant, the customer is guided by an attendant to the table 15 and is given one or more radio frequency identification menu 50, then the customer chooses a item 51 on the menu 50 to turn on the RFID tag switch 53 underneath the item 51, which transmits a signal to the reader 16 to show a pre-selection on a display device electrically connected with the reader 16; when the customer finished choosing the items 51 and even changing the items 51, he/she presses the confirm button 55 on the menu 50 to confirm the order;

Thereafter, the customer display device 10 transmits the confirmed items 51 to the corresponding kitchen display device 20, the service display device 30, and the host display device 40 simultaneously, wherein the kitchen display device 20 is provided for cooks to prepare food and cook, the service display device 30 is provided for the attendant to keep track of the ordering status of the table 15 and to prepare specific utensils 60, the host display device 40 is provided for the management desk or the counter to do the billing, preparing raw materials, managing personnel and to integrate the whole restaurant management process;

Later, after the meal is ready, the cook operates the RFID tag programmer 25 to generate a RFID tag 70 corresponding to the meal and attaches the RFID tag 70 to a corresponding utensil 60, and places the utensil 60 holding the meal at a corresponding service terminal. When a reader 35 at the service terminal reads the RFID tag 70, it shows the meal on the service display device 30 for the attendant to deliver the meal to the corresponding table 15 for the customer;

Finally, after the customer finishes his/her meal, the customer can ask the attendant to collect the used utensils 60 or the attendant can automatically collect the used utensils 60 by himself, wherein the utensils 60 are read by the reader 35 to make sure the meal has been served. Besides, after the meal is served, the host display device 40 at the counter can generate a bill to be shown on the customer display device 10 and the service display device 30 for the customer to check out.

In another preferred embodiment of the present invention, a payment mechanism comprising a credit card, an electronic wallet, or the like is integrated with the customer display device 10 and the host display device 40 to let the customer check out at the table 15 after the customer passes a simple security authentication online. Therefore, the customer doesn't have to pay at the counter and can save some time.

Hence, when the customer enters the restaurant, he/she can use the radio frequency identification menu 50 to order, the customer can order a meal by pressing a select button 52 corresponding to the item 51 to turn on the RFID tag switch 53 and to transmit a signal to the reader 16, wherein the reader 16 is electrically connected to a display device for showing the selected item 51 to the customer, and then the reader 16 can transmit the selected item 51 to the kitchen display device 20, the service display device 30, and the host display device 40 simultaneously to let the customer order his/her meal via radio frequency identification techniques and to let the kitchen, the attendant, and the counter to know the customer's requirements synchronously to integrate the whole restaurant management process. The ordering system using radio frequency identification can correctly deliver every dish to the corresponding table to improve the meal serving efficiency and to let the customer know the processing status of the meal; besides, the system can be provided for billing management to achieve restaurant management automation and to be more cost-effective.

The present invention discloses an ordering system using radio frequency identification, while compared to the citations and prior art techniques, is advantageous in:

1. The present invention can provide an ordering system using radio frequency identification which can guide a customer step by step through the ordering process based on practical operation and installation conditions to let the customer use the system efficiently.

2. The present invention provides an ordering system using radio frequency identification to let a customer order his/her meal with RFID techniques and to let the attendant at the counter and the kitchen to know the customer's requirements synchronously to integrate the whole restaurant management process.

3. The present invention provides an ordering system using radio frequency identification which can serve every dish correctly to the target table to improve the meal serving efficiency.

4. The present invention provides an ordering system using radio frequency identification which can let the customer be aware of the current processing status and can facilitate billing management to achieve restaurant management automation.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

What is claimed is:

1. An ordering system using radio frequency identification, comprising a menu having a RFID tag, wherein the menu having a RFID tag comprises items each disposed with a RFID tag switch underneath for a customer to select the item by pressing the RFID tag switch to turn on the switch and to transmit a signal to a reader; wherein the reader generates real-time ordering information to be shown on a display device and provided for corresponding the customer with an attendant for ordering information service.

2. The ordering system using radio frequency identification as claimed in claim 1, wherein the RFID tag transmits a signal to a reader for generating real-time ordering information on the display, the display further comprises a customer display device installed on a table for displaying, receiving and delivering ordering information.

3. The ordering system using radio frequency identification as claimed in claim 2, wherein the customer display device can be electrically connected to the menu and integrated with the menu as a single device.

4. The ordering system using radio frequency identification as claimed in claim 1, wherein the RFID tag transmits a signal to a reader for generating real-time ordering information on the display, the display further comprises a kitchen display device installed in a cooking terminal of the kitchen for displaying, receiving and delivering ordering information, wherein the kitchen display device comprises a user interface for inputting data, the kitchen display device also connects with a RFID tag programmer for generating one or more RFID tags corresponding to the ordering information to be attached to a utensil.

5. The ordering system using radio frequency identification as claimed in claim 1, wherein the RFID tag transmits a signal to a reader for generating real-time ordering information on the display, the display further comprises a service display device installed at an attendant post for displaying, receiving and delivering ordering information, wherein the service display device comprises a user interface for inputting data and connects with a reader.

6. The ordering system using radio frequency identification as claimed in claim 1, wherein the RFID tag transmits a signal to a reader for generating real-time ordering information on the display, the display further comprises a host display device installed at a management desk or a counter for displaying, receiving, delivering ordering information and managing backend data, wherein the host display device comprises a user interface for inputting data.

7. The ordering system using radio frequency identification as claimed in claim 1, wherein the menu can be a flexible display.

8. The ordering system using radio frequency identification as claimed in claim 1, wherein the menu comprises a select button for the customer to choose the items and a confirm button for the customer to confirm his/her order.

9. The ordering system using radio frequency identification as claimed in claim 1, wherein the customer display device and the host display device are linked with a payment mechanism comprising a credit card, an electronic wallet, or the like to let the customer check out at the table.
